(19) United States
(12) Patent Application Publication
(10) Pub. No.: US 2003/0057293 A1
(43) Pub. Date: Mar. 27, 2003

(54) Control valve for an injector of a fuel Injection system for internal combustion engines with pressure amplification in the control chamber

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 09/936,262

(22) PCT Filed: Dec. 22, 2000
(86) PCT No.: PCT/DE00/04590

(30) Foreign Application Priority Data
Jan. 13, 2000 (DE) 100 01 099.7

(51) Int. Cl. F02M 47/02

(52) U.S. Cl. 239/88

(57) ABSTRACT

A control valve (15) for injectors of injection systems for internal combustion engines is proposed, in which part of the displacement path of the final control element (45) serves the purpose of pressure elevation in the control chamber (11). The closing times of the nozzle needle (19) are thereby reduced.

### PRIOR ART

The invention relates to a control valve for the injector of a fuel injection system for internal combustion engines as generically defined by the preamble to claim 1 and to an injector for a fuel injection system for internal combustion engines as generically defined by the preamble to coordinate claim 15.

As technology becomes increasingly sophisticated, it is a goal to make the control valves of injectors, and the injectors themselves, as compact as possible and at the same time to achieve short closing times. From European Patent Disclosure EP 0 740 068 A2, an injector is known in which the control chamber is defined by an end face of the nozzle needle. A compact design can be achieved in this way. However, the closing speed of the nozzle needle is reduced by this provision, since an overcompensation for the hydraulic forces in the direction of the closing motion of the nozzle needle is not possible.

The object of the invention is to furnish a control valve for an injector which is compact in structure and makes high closing speeds of the injection nozzle possible.

According to the invention, this object is attained by a control valve for the injector of a fuel injection system for internal combustion engines, having a housing, wherein the control valve has a final control element and is actuated by an actuator, wherein by means of the control valve, a hydraulic communication can be established between a fuel return and a control chamber of the injector, wherein the final control element is operatively connected to a pressure piston, wherein the pressure piston hydraulically disconnects the control chamber from the control valve before a switching position of the control valve that hydraulically disconnects the control chamber from the control valve is reached, and wherein the remaining displacement path of the control valve until this switching position is reached serves the purpose of pressure elevation in the control chamber by means of the pressure piston.

### ADVANTAGES OF THE INVENTION

The control valve of the invention has the advantage that with the aid of a portion of the displacement motion of the control valve, positive displacement work is done in the control chamber, and thus the pressure in the control chamber is elevated by the displacement motion. As the result, a steeper pressure rise is obtained in the control chamber upon closure of the control valve, and thus also a steeper rise in the closing force acting on the nozzle needle. As a consequence, the closing duration is shortened. Because of the shortened closing duration, preinjection quantities can be metered more precisely, and the control of the main injection can also be done more accurately and with greater degrees of freedom.

In a variant of the invention, it is provided that the final control element and a bore of the housing form an annular chamber, whose first end communicates hydraulically with the fuel return and whose second end communicates hydraulically with the control chamber, and that the final control element is axially displaceable by means of a tappet guided in a first guide bore and has means for sealing off the annular chamber from the control chamber. In an alternative embodiment, the final control element has means for sealing off the annular chamber from the fuel return, so that the control valve of the invention can be achieved on the basis of a 2/2-way control valve or on the basis of a 2/3-way control valve.

In an expansion of the invention, it is provided that the pressure piston is connected to the final control element on the end thereof remote from the tappet; that coaxially to the first guide bore on the opposite end of the annular chamber, there is a second guide bore with a control edge; and that the second guide bore is closable by the pressure piston, beginning at the control edge, so that the positive displacement work in the control chamber is coupled simply and effectively with the displacement motion of the control valve.

In another feature of the invention, the means for sealing off the annular chamber from the fuel return and/or the means for sealing off the annular chamber from the control chamber each have one frustoconical sealing cone disposed coaxially to the longitudinal axis of the tappet, so that over the entire service life of the control valve, good sealing action is attained.

In a further expansion of the invention, it is provided that between the bore and the control chamber and fuel return, sealing faces are embodied, which cooperate with the means for sealing off the annular chamber from the control chamber and/or with the means for sealing off the annular chamber from the fuel return, resulting in a simple and space-saving disposition of the sealing faces.

Another feature of the invention provides that a closing spring is present, which acts on the final control element in the actuation direction of the actuator, so that even if system pressure is lacking, the control valve always assumes a defined switching position.

In another embodiment, the housing is embodied in two parts, facilitating both production and installation.

In an expansion of the invention, it is provided that the control valve is a 2/3-way control valve, so that the metering of the tiniest preinjection quantities is improved and at the same time large main injection quantities are possible.

In another feature of the invention, the face end of the tappet remote from the final control element and a piston actuated by the actuator define a fluid-filled pressure chamber of a hydraulic booster, so that the displacement path and the adjusting force of the actuator can be adapted to the requirements of the control valve of the invention, or of the injector.

In a variant of the invention, the actuator is a piezoelectric actuator, so that major adjusting forces and rapid response are assured.

In another embodiment of the invention, the final control element is rotationally symmetrical, and in particular is essentially cylindrical, or the final control element is embodied spherically, and that the means for sealing off the annular chamber from the fuel return and/or the means for sealing off the annular chamber from the control chamber are sealing lines extending on the spherical surface, so that depending on operating conditions, a suitable final control element is available.

In a further expansion of the invention, it is provided that the fuel injection system is a common rail injection system, so that the advantages of the control valve of the invention also benefit these injection systems.

The object stated at the outset is also attained according to the invention by an injector for a fuel injection system for internal combustion engines, having a housing and having a control valve actuated by an actuator; by means of the control valve, a hydraulic communication can be established between a fuel return and a control chamber of the injector, and the control valve is a control valve of one of the foregoing claims. This injector has the above-described advantages of the invention.

In an expansion of the invention, it is provided that the control chamber is defined by an end face of the nozzle needle, so that an especially compact design of the injector is obtained, and nevertheless the closing times of the injector of the invention are very short.

### DRAWING

Further advantages and advantageous features can be learned from the ensuing description, the drawing and the claims. Shown are:

FIG. 1: a schematically shown injector;

FIG. 2: an embodiment of a control valve of the invention in section; and

FIG. 3: the course of the pressure in the control chamber along with the associated control valve positions for two embodiments according to the invention.

### DESCRIPTION OF THE EXEMPLARY EMBODIMENTS

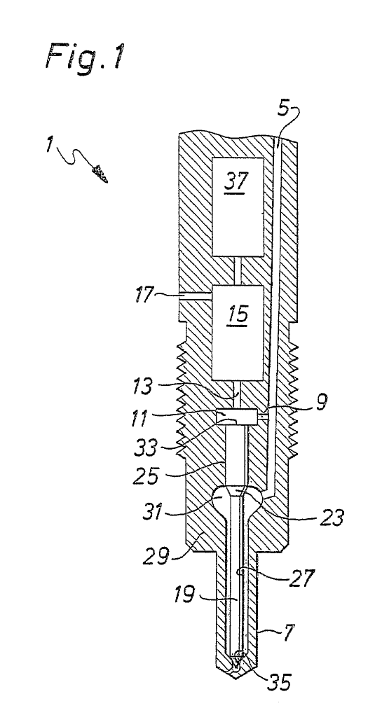

In FIG. 1, an injector 1 of the invention is shown. Via a high-pressure connection, not shown, fuel is delivered via an inlet conduit 5 to an injection nozzle 7 and via an inlet throttle 9 to a control chamber 11. The control chamber 11 communicates indirectly with a fuel return 17 via an outflow conduit, shown only schematically, with an outlet throttle 13 and via a schematically illustrated control valve 15.

The control chamber 11 is defined by a nozzle needle 19. The nozzle needle 19 prevents the fuel, which is under pressure, from flowing into the combustion chamber, not shown, between injections. The nozzle needle 19 has a cross-sectional change 23 from a larger diameter 25 to a smaller diameter 27. The nozzle needle 19 is guided with its larger diameter 25 in a housing 29. The cross-sectional change 23 defines a pressure chamber 31 of the injection nozzle 7.

When the outlet throttle 13 is closed, the hydraulic force exerted on an end face 33 of the nozzle needle 19 is greater than the hydraulic force acting on the cross-sectional change 23, because the end face 33 of the nozzle needle 19 is larger than the annular face of the cross-sectional change 23. As a consequence, the nozzle needle 19 is pressed into a nozzle needle seat 35 and seals off the inlet conduit 5 from the combustion chamber, not shown.

If the high-pressure pump, not shown, of the fuel injection system is not driven, which happens because the engine is stopped, then a nozzle spring, not shown, closes the injection nozzle 7 or injector 1.

When the control valve 15 is opened, fuel flows from the control chamber 11 into the fuel return. As a result, the pressure in the control chamber 11 drops, and the hydraulic force acting on the end face 33 of the nozzle needle 19 decreases. As soon as this hydraulic force is less than the hydraulic force acting on the cross-sectional change 23, the nozzle needle 19 opens, so that the fuel can reach the combustion chamber through the injection ports, not shown, of the injection nozzle 7. This indirect triggering of the nozzle needle 19 via a hydraulic force booster system is necessary because the major forces, required for fast opening of the nozzle needle 19, cannot be generated directly with the control valve 15. The so-called “control quantity” required in addition to the fuel quantity injected into the combustion chamber reaches the fuel return 17 via the inlet throttle 9, the control chamber 11, and the control valve 15.

In addition to the control quantity, a leakage also occurs where the nozzle needle is guided. The control and leakage quantities are returned to the fuel tank, not shown, again via the fuel return 17. Between injections, the control valve 15 and thus also the injection nozzle 7 are closed. The control valve 15 is actuated by a schematically shown actuator 37. A hydraulic pressure booster, not shown, may be present between the control valve 15 and the actuator 37.

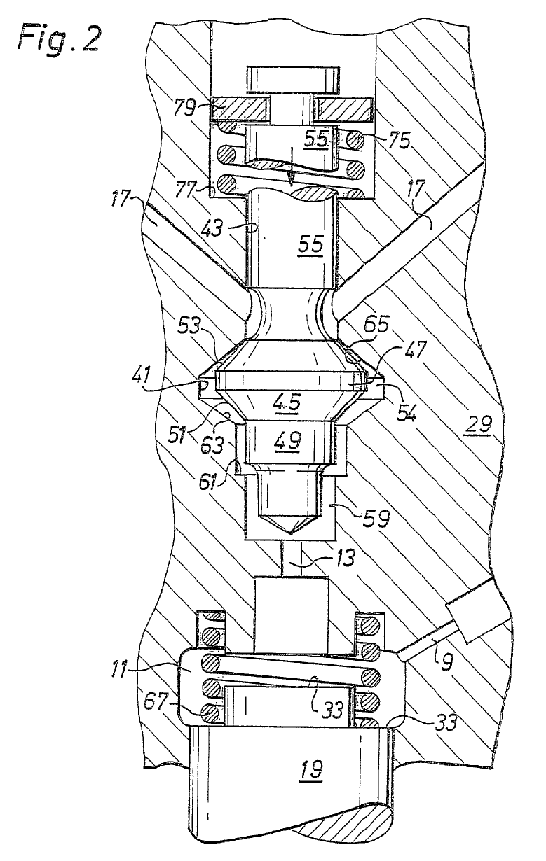

FIG. 2 shows one embodiment of a control valve 15 according to the invention. In the housing 29, a bore 41 is provided. Coaxially to the bore 41, there is a first guide bore 43. In the bore 41, there is a final control element 45, which has a collar 47, a pressure piston 49, and a first sealing cone 51 and a second sealing cone 53. The bore 41 and the collar 47 form an annular chamber 54. By suitable dimensioning, the annular chamber 54 can take over the function of the outlet throttle. A tappet 55, which is connected to the final control element 45, is guided in the first guide bore 43. The pressure piston 57 is disposed on the side of the final control element 45 opposite the tappet 55.

Between the annular chamber 54 and the outlet conduit with the outlet throttle 13, a second guide bore 59 is provided, embodied as a stepped bore. The shoulder of the second guide bore 59 represents a control edge 61 cooperating with the pressure piston 49. When the pressure piston 49 is moved so far into the second guide bore 59 that with its larger diameter it reaches the control edge 61, the hydraulic communication between the control chamber 11 and the fuel return 17 is interrupted.

Between the bore 41 and the second guide bore 59, a first ye 63 is formed in the housing 29; this ye, with the first sealing cone 51, can hydraulically disconnect the annular chamber 54 from the control chamber 11. The second sealing cone 53, together with a second ye 65 disposed between the bore 41 and the fuel return 17, can hydraulically disconnect the annular chamber 54 from the fuel return 17.

In the control chamber 11, there is a nozzle spring 67, which assures that the injection nozzle 7 remains closed even if fuel pressure is absent.

The control valve is actuated by an actuator, not shown, that acts on the tappet 55.

A closing spring 75 is braced on one end against a shoulder 77 of the housing 29 and on the other, via a Seeger ring 79, against the tappet 55. By means of the closing spring 75, it is assured that even if pressure is absent in the control chamber 11, the final control element 45 will be put into a first switching position a. Furthermore, the actuator is loaded only with pressure, which is important especially if piezoelectric actuators are used, because such actuators function reliably only in response to pressure.

The control valve 15 of the invention can be used as a 2/2-way control valve or a 2/3-way control valve. The mode of operation of the control valve 15 of the invention will be described below first with regard to three switching positions.

In the first switching position a, the second sealing cone 53 is seated on the second dt 65, and the fuel return 17 is hydraulically disconnected from the annular chamber 54.

In the second switching position b, the first sealing cone 51 is seated on the first dt 63, and the control chamber 11 is hydraulically disconnected from the annular chamber 54.

In both switching positions a and b, the control chamber 11 and fuel return 17 are hydraulically disconnected; that is, the injection nozzle 7 is closed.

At the transition from the first switching position a to the second switching position b, a hydraulic communication is briefly present between the control chamber 11 and the fuel return 17; that is, the pressure in the control chamber 11 at least partly collapses, and the injection nozzle 7 briefly opens. This brief opening is utilized for a preinjection. The preinjection quantity and duration can be defined with high replicability structurally by means of the design of the actuator and the outlet conduit with the outlet throttle 13, or of the annular chamber 54.

At the described transition from the first switching position a to the second b, a valve stroke c is reached, which is characterized in that the pressure piston 49 and the control edge 61 close off the control chamber 11 from the fuel return. During the remaining valve stroke until the switching position b is reached, the pressure piston 49 functions with regard to the control chamber 11 like the piston of a piston pump and elevates the pressure in the control chamber 11. As a result of the pressure elevation, the closing force acting on the nozzle needle 19 increases as well, which leads to a shortening of the closing duration.

In the third switching position d, the final control element 45 assumes an intermediate position, in which the first sealing cone 51 and second sealing cone 53 do not rest on the first dt 63 and the second dt 65, respectively. The injection occurs essentially simultaneously with the time interval within which the control valve 15 assumes the switching position d.

If the control valve 15 of the invention is operated as a 2/2-way control valve, then between injections it assumes the switching position b. The preinjection is tripped in that the switching position d and then the switching position b again are approached briefly. The main injection is performed in the same way, with the difference that the opening duration for the injection nozzle 7 is greater.

In this mode of operation, the closing duration of the nozzle needle 19 is reduced by the pressure piston 49 as described above both after the end of the preinjection and after the end of the main injection.

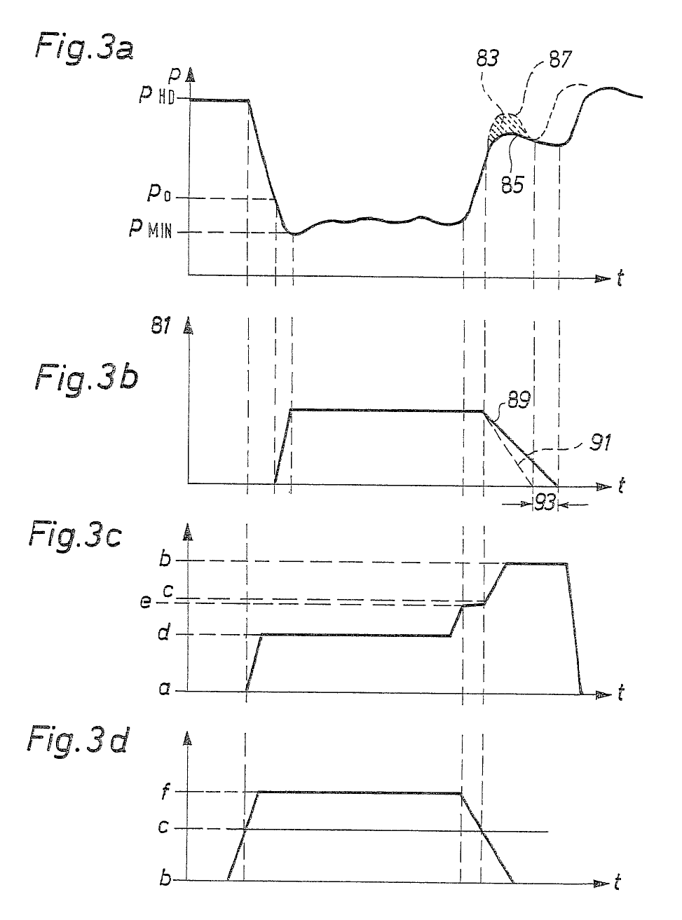

FIG. 3 shows the relationship between the switching positions, that is, the valve stroke of the control valve 15, the stroke 81 of the nozzle needle 19, and the pressure p in the control chamber 11.

FIG. 3a shows the pressure p in the control chamber 11 over time t. In FIG. 3b, the course over time of the stroke 81 of the nozzle needle 19 is plotted, and FIGS. 3c and 3d show the associated switching positions of the control valve 15. In FIG. 3c, the control valve 15 is operated as a 2/3-way valve, and in FIG. 3d the control valve 15 is operated as a 2/2-way valve.

Below, the mode of operation of the 2/3-way control valve 15 will first be described. Beginning at the first switching position a in FIG. 3c, the control valve 15 is moved by the actuator to the switching position d. As a consequence, the pressure p in the control chamber 11 collapses, beginning at p_{HD} (see FIG. 3a). As soon as the pressure p₀ is undershot, the nozzle needle 19 leaves the nozzle needle seat 35, and the injection begins. This process can be seen from studying FIGS. 3a and 3b together.

At the end of the injection, the final control element 45 of the control valve 15 is put into a switching position marked e in FIG. 3c. In this switching position, a throttling of the fuel flow from the control chamber 11 into the fuel return 17 takes place between the pressure piston 49 and the control edge 61. As a result, the pressure p in the control chamber 11 increases, as can be seen from FIG. 3a.

Once the pressure p in the control chamber 11 is high enough, the final control element 45 is moved into the second switching position b. As soon as the control valve 15 has reached the valve stroke c and the pressure piston 49 seals off the control chamber 11 from the fuel return 17 at the control edge 61, the pressure piston functions like a piston pump to elevate the pressure in the control chamber 11. The switching position e and the valve stroke c are in the immediate vicinity of one another, so that in the version chosen in FIG. 3c, they are virtually identical. The positive displacement work of the pressure piston 49 is represented in FIG. 3a as a shaded area 83. The solid line 85 represents the pressure course of a control valve of the prior art, while the dashed line 87 represents the pressure course of a control valve 15 according to the invention.

The shortening of the closing duration of the injector as a result of the pressure elevation in the control chamber 11 can be seen from FIG. 3b. The solid line 89 represents the closing motion of a nozzle needle of an injector in the prior art, while the dashed line 91 represents the closing motion of a nozzle needle of an injector 1 of the invention. The shortening of the closing duration of the injector as a result of the pressure elevation in the control chamber 11 is designated by reference numeral 93 in FIG. 3b.

During the transition between the two switching positions a and b, the nozzle needle 19 opens slightly, and the preinjection quantity is injected into the combustion chamber. To increase the preinjection quantity, the control valve 15 can also remain briefly in the switching position d during the preinjection.

The main injection, not shown in FIG. 3, takes place when the control valve is controlled from the second switching position b to the switching position d. This switching position is then maintained until such time as the requisite injection quantity has been injected. After that, the main injection is terminated by moving the control valve to the first switching position a. This sequence also makes another advantage of the control valve of the invention clear: The actuator, at the transition from the first switching position a to the second switching position b, must perform work only counter to the pressure in the control chamber 11, making the demand for driving energy very slight. Moreover, because the pressure in the control chamber is dropping during this transition, there is only a slight demand for power.

If the control valve 15 is operated as a 2/2-way control valve, the injection is tripped by moving the control valve 15 from the switching position b in FIG. 3d to an intermediate position f. When the valve stroke c is exceeded, the control valve 15 opens, and the pressure p in the control chamber 11 collapses. The injection is terminated when the control valve is moved from the intermediate position f back into the switching position b. Once the switching position c is reached, the pressure piston 49 seals off the control chamber 11 from the fuel return 17 at the control edge 61 and functions like a piston pump to elevate the pressure in the control chamber 11. The positive displacement work is shown in FIG. 3a as a shaded area 83. The solid line 85 represents the pressure course of a control valve of the prior art, while the dashed line 87 represents the pressure course of a control valve 15 of the invention.

All the characteristics recited and shown in the ensuing claims and drawing can be essential to the invention both individually and in arbitrary combination with one another.

### PRIOR ART

The invention relates to a control valve for the injector of a fuel injection system for internal combustion engines as generically defined by the preamble to claim 1 and to an injector for a fuel injection system for internal combustion engines as generically defined by the preamble to coordinate claim 15.

As technology becomes increasingly sophisticated, it is a goal to make the control valves of injectors, and the injectors themselves, as compact as possible and at the same time to achieve short closing times. From European Patent Disclosure EP 0 740 068 A2, an injector is known in which the control chamber is defined by an end face of the nozzle needle. A compact design can be achieved in this way. However, the closing speed of the nozzle needle is reduced by this provision, since an overcompensation for the hydraulic forces in the direction of the closing motion of the nozzle needle is not possible.

The object of the invention is to furnish a control valve for an injector which is compact in structure and makes high closing speeds of the injection nozzle possible.

According to the invention, this object is attained by a control valve for the injector of a fuel injection system for internal combustion engines, having a housing, wherein the control valve has a final control element and is actuated by an actuator, wherein by means of the control valve, a hydraulic communication can be established between a fuel return and a control chamber of the injector, wherein the final control element is operatively connected to a pressure piston, wherein the pressure piston hydraulically disconnects the control chamber from the control valve before a switching position of the control valve that hydraulically disconnects the control chamber from the control valve is reached, and wherein the remaining displacement path of the control valve until this switching position is reached serves the purpose of pressure elevation in the control chamber by means of the pressure piston.

### ADVANTAGES OF THE INVENTION

The control valve of the invention has the advantage that with the aid of a portion of the displacement motion of the control valve, positive displacement work is done in the control chamber, and thus the pressure in the control chamber is elevated by the displacement motion. As the result, a steeper pressure rise is obtained in the control chamber upon closure of the control valve, and thus also a steeper rise in the closing force acting on the nozzle needle. As a consequence, the closing duration is shortened. Because of the shortened closing duration, preinjection quantities can be metered more precisely, and the control of the main injection can also be done more accurately and with greater degrees of freedom.

In a variant of the invention, it is provided that the final control element and a bore of the housing form an annular chamber, whose first end communicates hydraulically with the fuel return and whose second end communicates hydraulically with the control chamber, and that the final control element is axially displaceable by means of a tappet guided in a first guide bore and has means for sealing off the annular chamber from the control chamber. In an alternative embodiment, the final control element has means for sealing off the annular chamber from the fuel return, so that the control valve of the invention can be achieved on the basis of a 2/2-way control valve or on the basis of a 2/3-way control valve.

In an expansion of the invention, it is provided that the pressure piston is connected to the final control element on the end thereof remote from the tappet; that coaxially to the first guide bore on the opposite end of the annular chamber, there is a second guide bore with a control edge; and that the second guide bore is closable by the pressure piston, beginning at the control edge, so that the positive displacement work in the control chamber is coupled simply and effectively with the displacement motion of the control valve.

In another feature of the invention, the means for sealing off the annular chamber from the fuel return and/or the means for sealing off the annular chamber from the control chamber each have one frustoconical sealing cone disposed coaxially to the longitudinal axis of the tappet, so that over the entire service life of the control valve, good sealing action is attained.

In a further expansion of the invention, it is provided that between the bore and the control chamber and fuel return, sealing faces are embodied, which cooperate with the means for sealing off the annular chamber from the control chamber and/or with the means for sealing off the annular chamber from the fuel return, resulting in a simple and space-saving disposition of the sealing faces.

Another feature of the invention provides that a closing spring is present, which acts on the final control element in the actuation direction of the actuator, so that even if system pressure is lacking, the control valve always assumes a defined switching position.

In another embodiment, the housing is embodied in two parts, facilitating both production and installation.

In an expansion of the invention, it is provided that the control valve is a 2/3-way control valve, so that the metering of the tiniest preinjection quantities is improved and at the same time large main injection quantities are possible.

In another feature of the invention, the face end of the tappet remote from the final control element and a piston actuated by the actuator define a fluid-filled pressure chamber of a hydraulic booster, so that the displacement path and the adjusting force of the actuator can be adapted to the requirements of the control valve of the invention, or of the injector.

In a variant of the invention, the actuator is a piezoelectric actuator, so that major adjusting forces and rapid response are assured.

In another embodiment of the invention, the final control element is rotationally symmetrical, and in particular is essentially cylindrical, or the final control element is embodied spherically, and that the means for sealing off the annular chamber from the fuel return and/or the means for sealing off the annular chamber from the control chamber are sealing lines extending on the spherical surface, so that depending on operating conditions, a suitable final control element is available.

In a further expansion of the invention, it is provided that the fuel injection system is a common rail injection system, so that the advantages of the control valve of the invention also benefit these injection systems.

The object stated at the outset is also attained according to the invention by an injector for a fuel injection system for internal combustion engines, having a housing and having a control valve actuated by an actuator; by means of the control valve, a hydraulic communication can be established between a fuel return and a control chamber of the injector, and the control valve is a control valve of one of the foregoing claims. This injector has the above-described advantages of the invention.

In an expansion of the invention, it is provided that the control chamber is defined by an end face of the nozzle needle, so that an especially compact design of the injector is obtained, and nevertheless the closing times of the injector of the invention are very short.

### DRAWING

Further advantages and advantageous features can be learned from the ensuing description, the drawing and the claims. Shown are:

FIG. 1: a schematically shown injector;

FIG. 2: an embodiment of a control valve of the invention in section; and

FIG. 3: the course of the pressure in the control chamber along with the associated control valve positions for two embodiments according to the invention.

### DESCRIPTION OF THE EXEMPLARY EMBODIMENTS

In FIG. 1, an injector 1 of the invention is shown. Via a high-pressure connection, not shown, fuel is delivered via an inlet conduit 5 to an injection nozzle 7 and via an inlet throttle 9 to a control chamber 11. The control chamber 11 communicates indirectly with a fuel return 17 via an outflow conduit, shown only schematically, with an outlet throttle 13 and via a schematically illustrated control valve 15.

The control chamber 11 is defined by a nozzle needle 19. The nozzle needle 19 prevents the fuel, which is under pressure, from flowing into the combustion chamber, not shown, between injections. The nozzle needle 19 has a cross-sectional change 23 from a larger diameter 25 to a smaller diameter 27. The nozzle needle 19 is guided with its larger diameter 25 in a housing 29. The cross-sectional change 23 defines a pressure chamber 31 of the injection nozzle 7.

When the outlet throttle 13 is closed, the hydraulic force exerted on an end face 33 of the nozzle needle 19 is greater than the hydraulic force acting on the cross-sectional change 23, because the end face 33 of the nozzle needle 19 is larger than the annular face of the cross-sectional change 23. As a consequence, the nozzle needle 19 is pressed into a nozzle needle seat 35 and seals off the inlet conduit 5 from the combustion chamber, not shown.

If the high-pressure pump, not shown, of the fuel injection system is not driven, which happens because the engine is stopped, then a nozzle spring, not shown, closes the injection nozzle 7 or injector 1.

When the control valve 15 is opened, fuel flows from the control chamber 11 into the fuel return. As a result, the pressure in the control chamber 11 drops, and the hydraulic force acting on the end face 33 of the nozzle needle 19 decreases. As soon as this hydraulic force is less than the hydraulic force acting on the cross-sectional change 23, the nozzle needle 19 opens, so that the fuel can reach the combustion chamber through the injection ports, not shown, of the injection nozzle 7. This indirect triggering of the nozzle needle 19 via a hydraulic force booster system is necessary because the major forces, required for fast opening of the nozzle needle 19, cannot be generated directly with the control valve 15. The so-called “control quantity” required in addition to the fuel quantity injected into the combustion chamber reaches the fuel return 17 via the inlet throttle 9, the control chamber 11, and the control valve 15.

In addition to the control quantity, a leakage also occurs where the nozzle needle is guided. The control and leakage quantities are returned to the fuel tank, not shown, again via the fuel return 17. Between injections, the control valve 15 and thus also the injection nozzle 7 are closed. The control valve 15 is actuated by a schematically shown actuator 37. A hydraulic pressure booster, not shown, may be present between the control valve 15 and the actuator 37.

FIG. 2 shows one embodiment of a control valve 15 according to the invention. In the housing 29, a bore 41 is provided. Coaxially to the bore 41, there is a first guide bore 43. In the bore 41, there is a final control element 45, which has a collar 47, a pressure piston 49, and a first sealing cone 51 and a second sealing cone 53. The bore 41 and the collar 47 form an annular chamber 54. By suitable dimensioning, the annular chamber 54 can take over the function of the outlet throttle. A tappet 55, which is connected to the final control element 45, is guided in the first guide bore 43. The pressure piston 57 is disposed on the side of the final control element 45 opposite the tappet 55.

Between the annular chamber 54 and the outlet conduit with the outlet throttle 13, a second guide bore 59 is provided, embodied as a stepped bore. The shoulder of the second guide bore 59 represents a control edge 61 cooperating with the pressure piston 49. When the pressure piston 49 is moved so far into the second guide bore 59 that with its larger diameter it reaches the control edge 61, the hydraulic communication between the control chamber 11 and the fuel return 17 is interrupted. Between the bore 41 and the second guide bore 59, a first ye 63 is formed in the housing 29; this ye, with the first sealing cone 51, can hydraulically disconnect the annular chamber 54 from the control chamber 11. The second sealing cone 53, together with a second ye 65 disposed between the bore 41 and the fuel return 17, can hydraulically disconnect the annular chamber 54 from the fuel return 17.

In the control chamber 11, there is a nozzle spring 67, which assures that the injection nozzle 7 remains closed even if fuel pressure is absent.

The control valve is actuated by an actuator, not shown, that acts on the tappet 55.

A closing spring 75 is braced on one end against a shoulder 77 of the housing 29 and on the other, via a Seeger ring 79, against the tappet 55. By means of the closing spring 75, it is assured that even if pressure is absent in the control chamber 11, the final control element 45 will be put into a first switching position a. Furthermore, the actuator is loaded only with pressure, which is important especially if piezoelectric actuators are used, because such actuators function reliably only in response to pressure.

The control valve 15 of the invention can be used as a 2/2-way control valve or a 2/3-way control valve. The mode of operation of the control valve 15 of the invention will be described below first with regard to three switching positions.

In the first switching position a, the second sealing cone 53 is seated on the second dt 65, and the fuel return 17 is hydraulically disconnected from the annular chamber 54.

In the second switching position b, the first sealing cone 51 is seated on the first dt 63, and the control chamber 11 is hydraulically disconnected from the annular chamber 54.

In both switching positions a and b, the control chamber 11 and fuel return 17 are hydraulically disconnected; that is, the injection nozzle 7 is closed.

At the transition from the first switching position a to the second switching position b, a hydraulic communication is briefly present between the control chamber 11 and the fuel return 17; that is, the pressure in the control chamber 11 at least partly collapses, and the injection nozzle 7 briefly opens. This brief opening is utilized for a preinjection. The preinjection quantity and duration can be defined with high replicability structurally by means of the design of the actuator and the outlet conduit with the outlet throttle 13, or of the annular chamber 54.

At the described transition from the first switching position a to the second b, a valve stroke c is reached, which is characterized in that the pressure piston 49 and the control edge 61 close off the control chamber 11 from the fuel return. During the remaining valve stroke until the switching position b is reached, the pressure piston 49 functions with regard to the control chamber 11 like the piston of a piston pump and elevates the pressure in the control chamber 11. As a result of the pressure elevation, the closing force acting on the nozzle needle 19 increases as well, which leads to a shortening of the closing duration.

In the third switching position d, the final control element 45 assumes an intermediate position, in which the first sealing cone 51 and second sealing cone 53 do not rest on the first dt 63 and the second dt 65, respectively. The injection occurs essentially simultaneously with the time interval within which the control valve 15 assumes the switching position d.

If the control valve 15 of the invention is operated as a 2/2-way control valve, then between injections it assumes the switching position b. The preinjection is tripped in that the switching position d and then the switching position b again are approached briefly. The main injection is performed in the same way, with the difference that the opening duration for the injection nozzle 7 is greater.

In this mode of operation, the closing duration of the nozzle needle 19 is reduced by the pressure piston 49 as described above both after the end of the preinjection and after the end of the main injection.

FIG. 3 shows the relationship between the switching positions, that is, the valve stroke of the control valve 15, the stroke 81 of the nozzle needle 19, and the pressure p in the control chamber 11.

FIG. 3a shows the pressure p in the control chamber 11 over time t. In FIG. 3b, the course over time of the stroke 81 of the nozzle needle 19 is plotted, and FIGS. 3c and 3d show the associated switching positions of the control valve 15. In FIG. 3c, the control valve 15 is operated as a 2/3-way valve, and in FIG. 3d the control valve 15 is operated as a 2/2-way valve.

Below, the mode of operation of the 2/3-way control valve 15 will first be described. Beginning at the first switching position a in FIG. 3c, the control valve 15 is moved by the actuator to the switching position d. As a consequence, the pressure p in the control chamber 11 collapses, beginning at p_{HD} (see FIG. 3a). As soon as the pressure p₀ is undershot, the nozzle needle 19 leaves the nozzle needle seat 35, and the injection begins. This process can be seen from studying FIGS. 3a and 3b together.

At the end of the injection, the final control element 45 of the control valve 15 is put into a switching position marked e in FIG. 3c. In this switching position, a throttling of the fuel flow from the control chamber 11 into the fuel return 17 takes place between the pressure piston 49 and the control edge 61. As a result, the pressure p in the control chamber 11 increases, as can be seen from FIG. 3a.

Once the pressure p in the control chamber 11 is high enough, the final control element 45 is moved into the second switching position b. As soon as the control valve 15 has reached the valve stroke c and the pressure piston 49 seals off the control chamber 11 from the fuel return 17 at the control edge 61, the pressure piston functions like a piston pump to elevate the pressure in the control chamber 11. The switching position e and the valve stroke c are in the immediate vicinity of one another, so that in the version chosen in FIG. 3c, they are virtually identical. The positive displacement work of the pressure piston 49 is represented in FIG. 3a as a shaded area 83. The solid line 85 represents the pressure course of a control valve of the prior art, while the dashed line 87 represents the pressure course of a control valve 15 according to the invention.

The shortening of the closing duration of the injector as a result of the pressure elevation in the control chamber 11 can be seen from FIG. 3b. The solid line 89 represents the closing motion of a nozzle needle of an injector in the prior art, while the dashed line 91 represents the closing motion of a nozzle needle of an injector 1 of the invention. The shortening of the closing duration of the injector as a result of the pressure elevation in the control chamber 11 is designated by reference numeral 93 in FIG. 3b.

During the transition between the two switching positions a and b, the nozzle needle 19 opens slightly, and the preinjection quantity is injected into the combustion chamber. To increase the preinjection quantity, the control valve 15 can also remain briefly in the switching position d during the preinjection.

The main injection, not shown in FIG. 3, takes place when the control valve is controlled from the second switching position b to the switching position d. This switching position is then maintained until such time as the requisite injection quantity has been injected. After that, the main injection is terminated by moving the control valve to the first switching position a. This sequence also makes another advantage of the control valve of the invention clear: The actuator, at the transition from the first switching position a to the second switching position b, must perform work only counter to the pressure in the control chamber 11, making the demand for driving energy very slight. Moreover, because the pressure in the control chamber is dropping during this transition, there is only a slight demand for power.

If the control valve 15 is operated as a 2/2-way control valve, the injection is tripped by moving the control valve 15 from the switching position b in FIG. 3d to an intermediate position f. When the valve stroke c is exceeded, the control valve 15 opens, and the pressure p in the control chamber 11 collapses. The injection is terminated when the control valve is moved from the intermediate position f back into the switching position b. Once the switching position c is reached, the pressure piston 49 seals off the control chamber 11 from the fuel return 17 at the control edge 61 and functions like a piston pump to elevate the pressure in the control chamber 11. The positive displacement work is shown in FIG. 3a as a shaded area 83. The solid line 85 represents the pressure course of a control valve of the prior art, while the dashed line 87 represents the pressure course of a control valve 15 of the invention.

All the characteristics recited and shown in the ensuing claims and drawing can be essential to the invention both individually and in arbitrary combination with one another.

1. A control valve for the injector (1) of a fuel injection system for internal combustion engines, having a housing, wherein the control valve (15) has a final control element (45) and is actuated by an actuator (37), wherein by means of the control valve (15), a hydraulic communication can be established between a fuel return (17) and a control chamber (11) of the injector (1), characterized in that the final control element (45) is operatively connected to a pressure piston (49); that the pressure piston (49) hydraulically disconnects the control chamber (11) from the control valve (15) before a switching position (b) of the control valve (15) that hydraulically disconnects the control chamber (11) from the control valve (15) is reached; and that the remaining displacement path of the control valve (15) until this switching position (b) is reached serves the purpose of pressure elevation in the control chamber (11) by means of the pressure piston (49).

2. The control valve of claim 1, characterized in that the final control element (45) and a bore (41) of the housing (29) form an annular chamber (54), whose first end communicates hydraulically with the fuel return (17) and whose second end communicates hydraulically with the control chamber (11), and that the final control element (45) is axially displaceable by means of a tappet (55) guided in a first guide bore (43) and has means (51) for sealing off the annular chamber (54) from the control chamber (11).

3. The control valve of claim 1 or 2, characterized in that the final control element (45) has means (53) for sealing off the annular chamber (54) from the fuel return (17).

4. The control valve of one of claims 2 and 3, characterized in that the pressure piston (49) is connected to the final control element (45) on the end thereof remote from the tappet (55); that coaxially to the first guide bore (43) on the opposite end of the annular chamber (54), there is a second guide bore (59) with a control edge (61); and that the second guide bore (59) is closable by the pressure piston (49), beginning at the control edge (61).

5. The control valve of one of claims 2-4, characterized in that the means (53, 51) for sealing off the annular chamber (54) from the fuel return (17) and/or the means (51) for sealing off the annular chamber (54) from the control chamber (11) each have one frustoconical sealing cone (53, 51) disposed coaxially to the longitudinal axis of the tappet (55).

6. The control valve of one of claims 2-5, characterized in that between the bore (41) and the control chamber (11) and fuel return (17), sealing faces (63, 65) are embodied, which cooperate with the means (51) for sealing off the annular chamber (54) from the control chamber (11) and/or with the means (53) for sealing off the annular chamber (54) from the fuel return (17).

7. The control valve of one of the foregoing claims, characterized in that a closing spring (75) is present, which acts on the final control element (45) in the actuation direction of the actuator (37).

8. The control valve of one of the foregoing claims, characterized in that the housing (29) is embodied in one piece.

9. The control valve of one of the foregoing claims, characterized in that the control valve (15) is a 2/3-way control valve.

10. The control valve of one of the foregoing claims, characterized in that the face end of the tappet (55) remote from the final control element (45) and a piston actuated by the actuator (37) define a fluid-filled pressure chamber of a hydraulic booster.

11. The control valve of one of the foregoing claims, characterized in that the actuator (37) is a piezoelectric actuator.

12. The control valve of one of the foregoing claims, characterized in that the final control element (45) is rotationally symmetrical, and in particular is essentially cylindrical.

13. The control valve of one of claims 1-11, characterized in that the final control element (45) is embodied spherically, and that the means (53) for sealing off the annular chamber (54) from the fuel return (17) and/or the means (51) for sealing off the annular chamber (54) from the control chamber (11) are sealing lines extending on the spherical surface.

14. The control valve of one of the foregoing claims, characterized in that the fuel injection system is a common rail injection system.

15. An injector (1) for a fuel injection system for internal combustion engines, having a housing (29) and having a control valve (15) actuated by an actuator (37), wherein by means of the control valve (15) a hydraulic communication can be established between a fuel return (15) and a control chamber (11) of the injector (1), characterized in that the control valve (15) is a control valve of one of the foregoing claims.

16. The injector (1) of claim 15, characterized in that the control chamber (11) is defined by an end face (33) of the nozzle needle (19).
